(19) United States
(12) Patent Application Publication
(10) Pub. No.: US 2021/0301206 A1
(43) Pub. Date: Sep. 30, 2021

(54) LIQUID CRYSTAL MATERIAL COMPOSITION AND DISPLAY DEVICE

(71) Applicant: Japan Display Inc., Tokyo (JP)

(72) Inventors: Kentaro OKUYAMA, Tokyo (JP); Kojiro IKEDA, Tokyo (JP); Tenfu NAKAMURA, Tokyo (JP)

(21) Appl. No.: 17/214,240

(22) Filed: Mar. 26, 2021

(30) Foreign Application Priority Data
Mar. 26, 2020 (JP) 2020-056410

(51) Int. Cl. C09K 19/54; C09K 19/32; G02F 1/1337

(52) U.S. Cl. CPC C09K 19/542; G02F 1/1337; C09K 19/322

(57) ABSTRACT

According to one embodiment, a liquid crystal material composition includes a liquid crystal mixture containing at least one kind of each of a first liquid crystalline compound, a second liquid crystalline compound and a third liquid crystalline compound, a polymerization initiator and a monomer compound including acryloyl groups at respective terminals.

### CROSS-REFERENCE TO RELATED APPLICATIONS

This application is based upon and claims the benefit of priority from Japanese Patent Application No. 2020-056410, filed Mar. 26, 2020, the entire contents of which are incorporated herein by reference.

### FIELD

Embodiments described herein relate generally to a liquid crystal material composition and display device.

### BACKGROUND

Recently, various types of illumination devices employing polymer dispersed liquid crystal (which may be referred to as “PDLC” hereinafter) capable of switching a diffusing state of diffusing incident light and a transmitting state of causing the incident light to be transmitted have been proposed.

On the other hand, there is a demand of improving the display quality in the display devices which employ PDLC.

### SUMMARY

The present disclosure relates generally to a liquid crystal material composition and a display device.

According to an embodiment, a liquid crystal material composition includes a liquid crystal mixture containing at least one kind of each of a first liquid crystalline compound, a second liquid crystalline compound and a third liquid crystalline compound, a polymerization initiator and a monomer compound including acryloyl groups at respective terminals.

### BRIEF DESCRIPTION OF THE DRAWINGS

FIG. 1 is a plan view showing a configuration example of a display device according to an embodiment.

FIG. 2 is a perspective view showing the display device shown in FIG. 1.

FIG. 3 is a cross-sectional view showing the display device shown in FIG. 1.

FIG. 4 is a cross-sectional view showing a configuration example of a display panel shown in FIG. 3.

FIG. 5 is a diagram schematically showing a liquid crystal layer in an OFF state.

FIG. 6 is a diagram schematically showing the liquid crystal layer in an ON state.

FIG. 7 is a cross-sectional view showing the display panel when the liquid crystal layer is in the OFF state.

FIG. 8 is a cross-sectional view showing the display panel when it includes a region where the liquid crystal layer is in the ON state.

### DETAILED DESCRIPTION

In general, according to one embodiment, a liquid crystal material composition comprises a liquid crystal mixture containing at least one kind of a first liquid crystalline compound, at least one kind of a second liquid crystalline compound and at least one kind of a third liquid crystalline compound, a polymerization initiator and a monomer compound including acryloyl groups at respective terminals, and the at least one kind of the first liquid crystalline compound contains a first aromatic ring including a halogens group, a second aromatic ring including a halogens group and bonded to the first aromatic ring through a first bond, and a third aromatic ring including an aliphatic group and bonded to the second aromatic ring through a second bond, the at least one kind of the second liquid crystalline compound contains a first aromatic ring including a halogens group, a second aromatic ring including a halogens group and bonded to the first aromatic ring through the first bond and a first alicyclic group including an aliphatic group and bonded to the second aromatic ring through a third bond, and the at least one kind of the third liquid crystalline compound contains a fourth aromatic ring, a fifth aromatic ring bonded to the fourth aromatic ring through a fourth bond, a second alicyclic group including an aliphatic group and bonded to the fourth aromatic ring through a fifth bond, and a third alicyclic group including an aliphatic group and bonded to the fifth aromatic ring through a sixth bond.

According to another embodiment, a display device comprises a first substrate, a second substrate opposing the first substrate, a liquid crystal layer located between the first substrate and the second substrate and containing a liquid crystal mixture containing at least one kind of a first liquid crystal compound, at least one kind of a second liquid crystalline compound and at least one kind of a third liquid crystalline compound, and a polymer originated from a monomer compound including acryloyl groups at respective terminals and an alignment film located on the first substrate and in contact with the liquid crystal layer, and the at least one kind of the first liquid crystalline compound contains a first aromatic ring including a halogens group, a second aromatic ring including a halogens group and bonded to the first aromatic ring through a first bond, and a third aromatic ring including an aliphatic group and bonded to the second aromatic ring through a second bond, the at least one kind of the second liquid crystalline compound contains a first aromatic ring including a halogens group, a second aromatic ring including a halogens group and bonded to the first aromatic ring through the first bond and a first alicyclic group including an aliphatic group and bonded to the second aromatic ring through a third bond, and the at least one kind of the third liquid crystalline compound contains a fourth aromatic ring, a fifth aromatic ring bonded to the fourth aromatic ring through a fourth bond, a second alicyclic group including an aliphatic group and bonded to the fourth aromatic ring through a fifth bond, and a third alicyclic group including an aliphatic group and bonded to the fifth aromatic ring through a sixth bond.

Embodiments will be described hereinafter with reference to the accompanying drawings. The disclosure is a mere example, and arbitrary change of gist which can be easily conceived by a person of ordinary skill in the art naturally falls within the inventive scope. To more clarify the explanations, the drawings may pictorially show width, thickness, shape and the like, of each portion as compared with an actual aspect, but they are mere examples and do not restrict the interpretation of the invention. In the present specification and drawings, elements like or similar to those in the already described drawings may be denoted by similar reference numbers and their detailed descriptions may be arbitrarily omitted.

<Display Device>

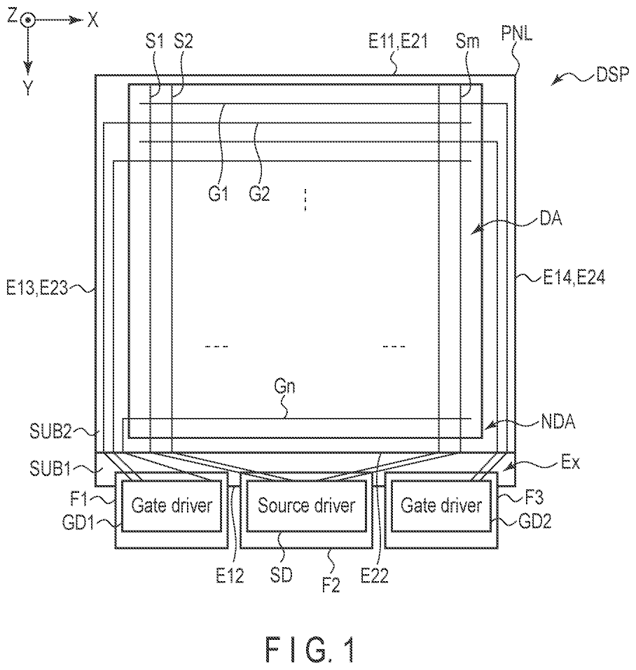

FIG. 1 is a plan view showing a configuration example of a display device DSP according to an embodiment. In the drawing, a first direction X, a second direction Y and a third direction Z are orthogonal to each other, but may intersect at an angle other than ninety degrees. In the present specification, a position of a distal side of arrow indicating the third direction Z is called an upper position while a position of a back side of the arrow is called a lower position. With such expressions as “a second member above a first member” and “a second member below a first member”, the second member may be in contact with the first member or may be remote from the first member. In addition, an observation position at which the display device DSP is observed is assumed to be located on the distal side of the arrow indicating the third direction Z, and viewing from the observation position toward an X-Y plane defined by the first direction X and the second direction Y is called a planer view.

In the embodiment, a display device employing polymer dispersed liquid crystal will be explained as an example of the display device DSP. The display device DSP comprises a display panel PNL and wiring substrates F1 to F3. In addition, the display device DSP also comprises a light source unit (not shown).

The display panel PNL includes a first substrate SUB1 and a second substrate SUB2. The first substrate SUB1 and the second substrate SUB2 are each formed into a flat plate shape parallel to the X-Y plane. The first substrate SUB1 and the second substrate SUB2 overlap in a planer view. The display panel PNL includes a display area DA which displays images and a frame-shaped non-display area NDA surrounding the display area DA. The display area DA is located in a region where the first substrate SUB1 and the second substrate SUB2 overlap. The display panel PNL includes n scanning lines G (G1 to Gn) and m signal lines S (S1 to Sm), in the display area DA. Note that each of n and m is a positive integer, and n may be equal to or different from m. The scanning lines G extend along the first direction X and are arranged to be spaced apart from each other along the second direction Y. The signal lines S extend along the second direction Y and are arranged to be spaced apart from each other along the first direction X.

The first substrate SUB1 includes end portions E11 and E12 extending along the first direction X and end portions E13 and E14 extending along the second direction Y. The second substrate SUB2 includes end portions E21 and E22 extending along the first direction X and end portions E23 and E24 extending along the second direction Y. In the example illustrated, the end portions E11 and E21, the end portions E13 and E23, and the end portions E14 and E24 overlap in planar view, but may not overlap. The end portion E22 is located between the end portion E12 and the display area DA in planar view. The first substrate SUB1 includes an extension portion Ex between the end portions E12 and E22.

The wiring substrates F1 to F3 are each bonded to the extension portion Ex and arranged in this order along the first direction X. The wiring substrate F1 comprises a gate driver GD1. The wiring substrate F2 comprises a source driver SD. The wiring substrate F3 comprises a gate driver GD2. Note that the wiring substrates F1 to F3 may be replaced with a single wiring substrate.

The signal lines S are drawn to the non-display area NDA and bonded to the source driver SD. The scanning lines G are drawn to the non-display area NDA and bonded to the gate drivers GD1 and GD2. In the example illustrated, odd-numbered scanning lines G are drawn between the end portion E14 and the display area DA and bonded to the gate driver GD2. Meanwhile, even-numbered scanning lines G are drawn between the end portion E13 and the display area DA and bonded to the gate driver GD1. Note that the connection between the gate drivers GD1 and GD2 and the scanning lines G in relation to each other is not limited to that of the example illustrated.

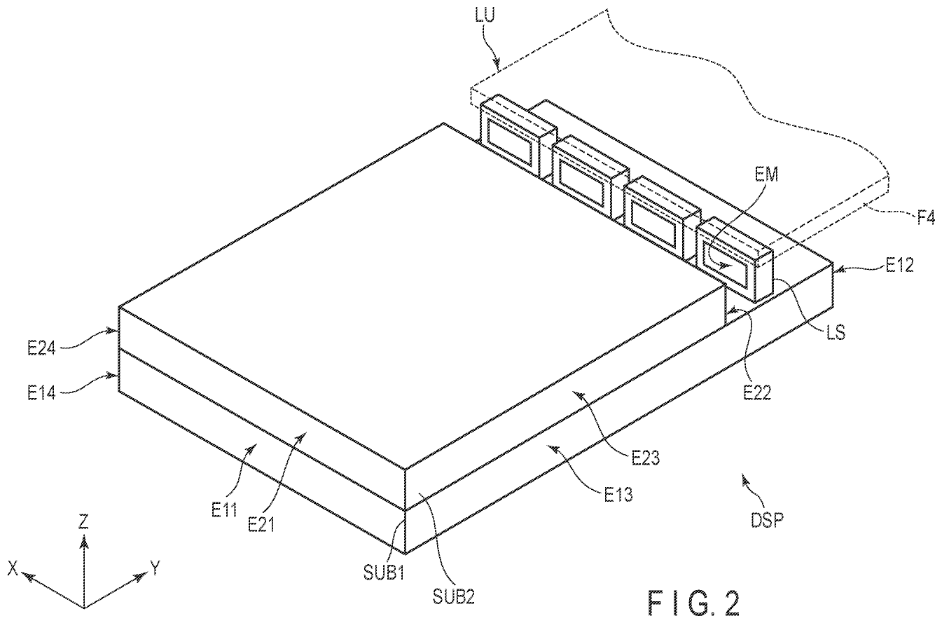

FIG. 2 is a perspective view showing the display device DSP shown in FIG. 1. Here, illustration of the wiring substrates F1 to F3 is omitted. A light source unit LU is located on the first substrate SUB1 and disposed along the end portion E22. The light source unit LU comprises light-emitting elements LS as light sources and a wiring substrate F4 indicated by a dotted line. The light-emitting elements LS are, for example, light-emitting diodes. The light-emitting elements LS are arranged to be spaced apart from each other along the first direction X. Each of the light-emitting elements LS is bonded to the wiring substrate F4. The light-emitting elements LS are located between the first substrate SUB1 and the wiring substrate F4. Each of the light-emitting elements LS comprises a light-emitting portion EM. Each light-emitting portion EM faces the end portion E22. The light-emitting portion EM may be in contact with the end portion E22. Further, an air layer, an optical element and the like may be interposed between the light-emitting portion EM and the end portion E22. The end portion E22 corresponds to an incidence portion where the light emitted from the light-emitting portion EM enters.

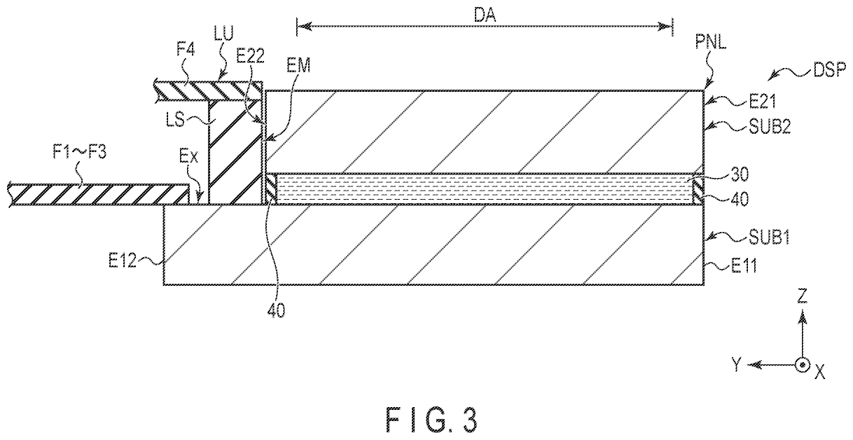

FIG. 3 is a cross-sectional view showing the display device DSP shown in FIG. 1. Only main portions in the cross-section of the display device DSP in a Y-Z plane defined by the second direction Y and the third direction Z will be explained here. The display panel PNL comprises a liquid crystal layer 30 held between the first substrate SUB1 and the second substrate SUB2. The first substrate SUB1 and the second substrate SUB2 are bonded to each other by a sealant 40.

In the example illustrated, the light-emitting elements LS are located between the extension portion Ex and the wiring substrate F4. Further, the light-emitting element LS is located between the wiring substrate F1 to F3 and the second substrate SUB2. The light-emitting elements LS emit light from the light-emitting portions EM to the end portion E22. The light entering from the end portion E22 propagates in the display panel PNL in an opposite direction to the arrow indicating the second direction Y, as will be described later. Note that the light-emitting elements LS may be opposed to the end portions of both the first substrate SUB1 and the second substrate SUB2, that is, for example, the end portions E11 and E21.

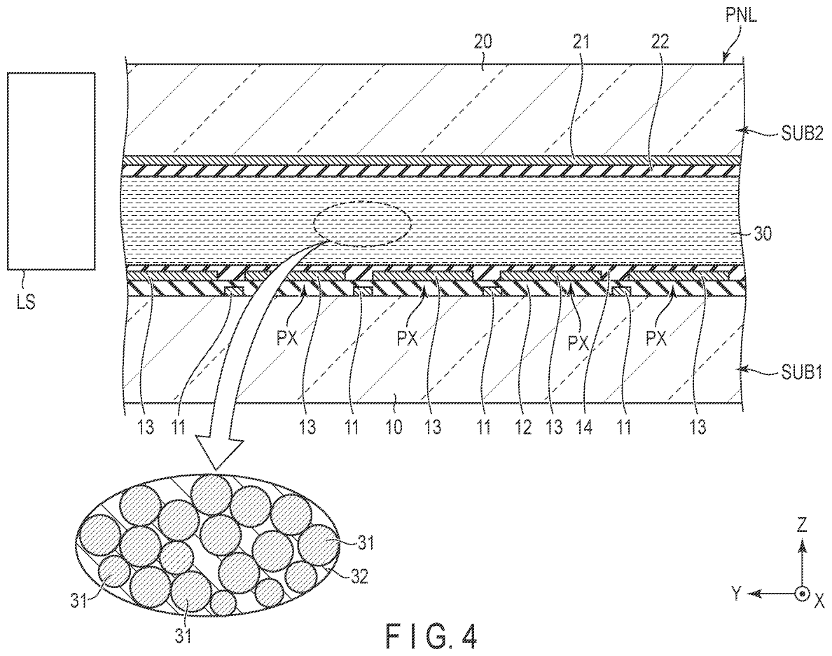

FIG. 4 is a cross-sectional view showing a configuration example of the display panel PNL shown in FIG. 3. The first substrate SUB1 comprises a transparent substrate 10, wiring lines 11, an insulating layer 12, pixel electrodes 13, and an alignment film 14. The second substrate SUB2 comprises a transparent substrate 20, a common electrode 21, and an alignment film 22. The transparent substrates 10 and 20 are insulating substrates such as glass substrates or plastic substrates. The conductive lines 11 are formed of an untransparent metal material such as molybdenum, tungsten, aluminum, titanium or silver. The illustrated conductive lines 11 extend in the first direction X but may extend in the second direction Y. The insulating layer 12 is formed of a transparent insulating material. The pixel electrodes 13 and the common electrode 21 are formed of a transparent conductive material such as indium tin oxide (ITO) or indium zinc oxide (IZO). The pixel electrodes 13 are disposed in pixels PX, respectively. The common electrode 21 is disposed across over the pixels PX. The alignment films 14 and 22 may be horizontal alignment films having an alignment restriction force approximately parallel to the X-Y plane or may be a vertical alignment films having an alignment restriction force approximately parallel to the third direction Z.

The liquid crystal layer 30 is located between the alignment films 14 and 22. The liquid crystal layer 30 is formed of a liquid crystal material composition, which will be described in detail later and comprises polymer dispersed liquid crystal containing polymers 31 and liquid crystal compound 32. The polymers are those originated from a monomer compound containing acryloyl groups respectively at both terminals, as will be described in detail later. The polymers can be obtained by, for example, polymerizing monomer compounds in a state of being aligned in a predetermined direction by the alignment restriction force of the alignment films 14 and 22. For example, the alignment treatment direction of the alignment films 14 and 22 agrees with the first direction X, and the alignment films 14 and 22 have the alignment restriction force along the first direction X. Therefore, the polymers 31 are formed into a strip shape extending along the first direction X. The liquid crystal compounds 32 are dispersed in gaps of the polymers 31, and the liquid crystal compounds of the liquid crystal compounds 32 are aligned such that their longitudinal axes extend along the first direction X.

The polymers 31 and the liquid crystal compounds 32 each have optical anisotropy or refractive anisotropy. The liquid crystal compounds 32 may be of a positive liquid crystal compound having a positive dielectric anisotropy or a negative liquid crystal compound having a negative dielectric anisotropy. The polymers 31 and the liquid crystal compounds 32 have different response performances to an electric field. The response performance of the polymers 31 to the electric field is lower than the response performance of the liquid crystal compounds 32 to the electric field. In the enlarged portion in the drawing, the polymers 31 are represented by upward-sloping hatch lines, and the liquid crystal compounds 32 are represented by downward-sloping hatch lines.

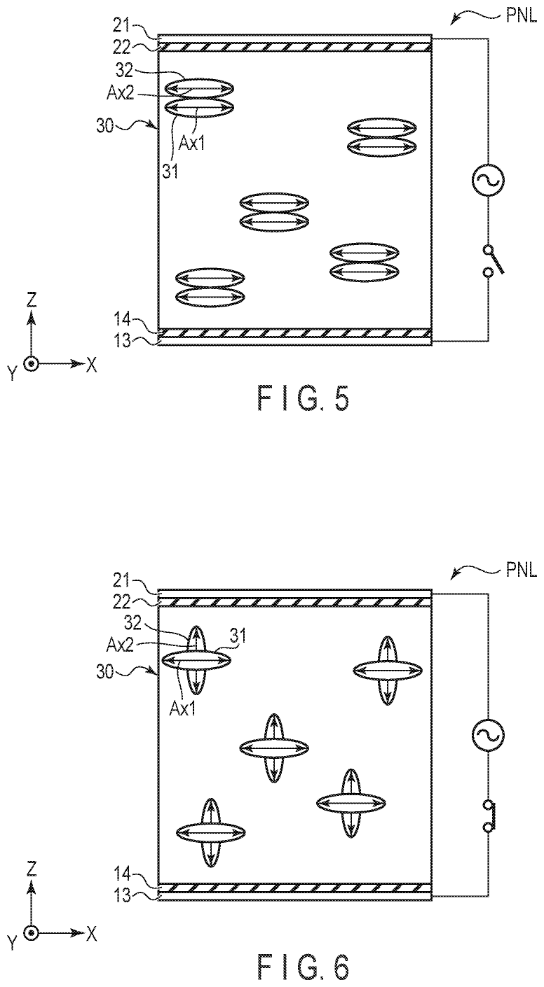

FIG. 5 is a diagram schematically showing the liquid crystal layer 30 in an OFF state. Here, a cross section of the liquid crystal layer 30 in the intersect X-Z plane intersecting the second direction Y, which is the direction of travel of the light from the light source unit LU is shown. The OFF state is equivalent to a state in which no voltage is applied to the liquid crystal layer 30 (for example, a state in which a potential difference between the pixel electrode 13 and the common electrode 21 is approximately zero). An optical axis Ax1 of the polymers 31 and an optical axis Ax2 of the liquid crystal compounds 32 are parallel to each other. In the example illustrated, each of the optical axis Ax1 and the optical axis Ax2 is parallel to the first direction X. The polymers 31 and the liquid crystal compounds 32 have refractive anisotropies approximately equal to each other. In other words, ordinary refractive indexes of the polymers 31 and the liquid crystalline compounds 32 are approximately equal to each other, and extraordinary refractive indexes of the polymers 31 and the liquid crystal compounds 32 are approximately equal to each other. Therefore, in all directions including the first direction X, the second direction Y and the third direction Z, there is no substantial difference in refractive index between the polymers 31 and the liquid crystal compounds 32.

FIG. 6 is a diagram schematically showing the liquid crystal layer 30 in an ON state. The ON state is equivalent a state in which voltage is applied to the liquid crystal layer 30 (for example, a state in which a potential difference between the pixel electrode 13 and the common electrode 21 is greater than or equal to a threshold value). As explained above, the response performance of the polymers 31 to the electric field is lower than the response performance of the liquid crystal compounds 32 to the electric field. For example, the direction of alignment of the polymers 31 does not substantially vary regardless of the presence or absence of the electric field. By contrast, in a state in which a voltage higher than the threshold value is applied to the liquid crystal layer 30, the direction of alignment of the liquid crystal compounds 32 varies in accordance with the electric field. That is, as illustrated in the drawing, the optical axis Ax1 is substantially parallel to the first direction X, whereas the optical axis Ax2 is oblique to the first direction X. When the liquid crystal compounds 32 is of a positive type liquid crystal compound, the liquid crystal compounds 32 are aligned such that the longitudinal axes thereof extended along the electric field. An electric field between the pixel electrode 13 and the common electrode 21 is formed along the third direction Z. For this reason, the liquid crystal compounds 32 are aligned such that the longitudinal axes or the optical axes Ax2 correspond to the third direction Z. That is, the optical axes Ax1 and optical axes Ax2 intersect each other. Therefore, a large difference in refractive index is created between the polymers 31 and the liquid crystal compounds 32 in all directions including the first direction X, the second direction Y and the third direction Z.

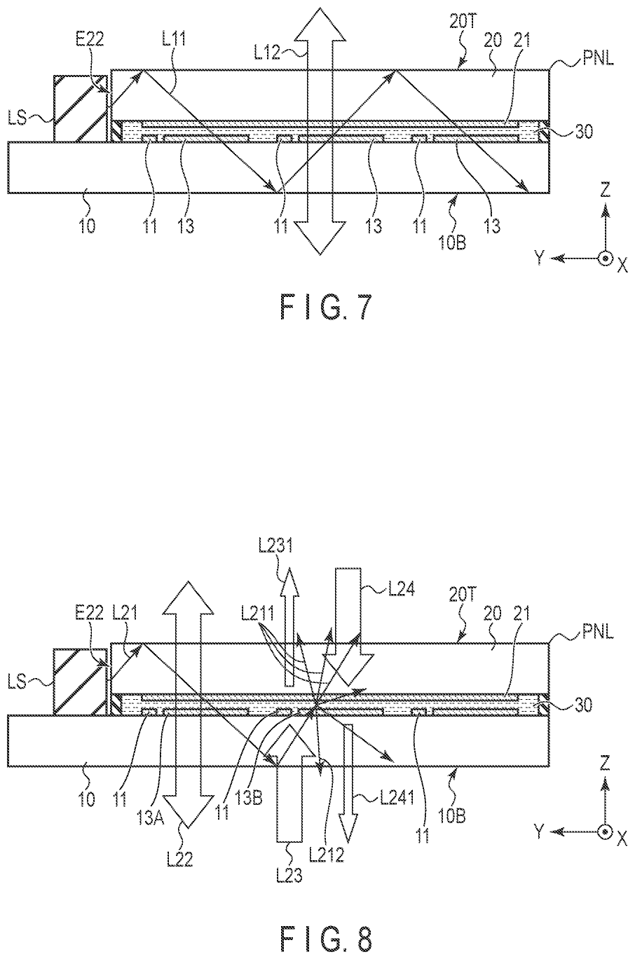

FIG. 7 is a cross-sectional view showing the display panel PNL in the case where the liquid crystal layer 30 is in the OFF state. A light beam L11 emitted from the light-emitting element LS enters the display panel PNL from the end portion E22, and propagates through the transparent substrate 20, the liquid crystal layer 30, the transparent substrate 10 and the like. When the liquid crystal layer 30 is in the OFF state, the light beam L11 is transmitted through the liquid crystal layer 30 without being substantially scattered. The light beam L11 is transmitted through the display panel PNL without substantially leaking out from a lower surface 10B of the transparent substrate 10 and an upper surface 20T of the transparent substrate 20. That is, the liquid crystal layer 30 is in a transparent state.

An external natural light beam L12 entering the display panel PNL is transmitted through the liquid crystal layer 30 without being scattered. That is, the external natural light entering the display panel PNL from the lower surface 10B is transmitted through the upper surface 20T, and the external natural light entering the display panel PNL from the upper surface 20T is transmitted through the lower surface 10B. Therefore, when the user observes the display panel PNL from an upper surface 20T side, the background on a lower surface 10B side can be visually recognized through the display panel PNL. Similarly, when the user observes the display panel PNL from the lower surface 10B side, the background on the upper surface 20T side through the display panel PNL can be visually recognized.

FIG. 8 is a cross-sectional view showing the display panel PNL in the case where the liquid crystal layer 30 includes a region which is in the ON state. A light beam L21 emitted from the light-emitting element LS enters the display panel PNL from the end portion E22 and propagates through the transparent substrate 20, the liquid crystal layer 30, the transparent substrate 10 and the like. In the example illustrated, the portion of the liquid crystal layer 30, which overlaps the pixel electrode 13A is in the OFF state, and the portion of the liquid crystal layer 30, which overlaps the pixel electrode 13B is in the ON state. Therefore, the light beam L21 is transmitted through the region of the liquid crystal layer 30, which overlaps the pixel electrode 13A without being substantially scattered and is scattered in the region overlapping the pixel electrode 13B. Of the light beam L21, a portion thereof, that is, a scattered light beam L211 is transmitted through the upper surface 20T, and another portion thereof, that is, a scattered light beam L212 is transmitted through the lower surface 10B. The other scatter light beams propagate inside the display panel PNL.

In the region overlapping the pixel electrode 13A, an external natural light beam L22 entering the display panel PNL is transmitted without being substantially scattered by the liquid crystal layer 30, as in the case of the external natural light beam L12 shown in FIG. 7. In the region overlapping the pixel electrode 13B, an external natural light beam L23 entering from the lower surface 10B is partially scattered in the liquid crystal layer 30, whereas a part thereof, a light beam L231 is transmitted through the upper surface 20T. Further, an external natural light beam L24 entering from the upper surface 20T is partially scattered in the liquid crystal layer 30, whereas a part thereof, a light beam L241 is transmitted through the lower surface 10B. Therefore, when the user observes the display panel PNL from the upper surface 20T side, the color of the light beam L21 can be visually recognized in the region overlapping the pixel electrode 13B. In addition, the partial external natural light beam L231 is transmitted through the display panel PNL, and therefore the user can also visually recognize the background on the lower surface 10B side through the display panel PNL. Similarly, when the user observes the display panel PNL from the lower surface 10B side, the color of the light beam L21 can be visually recognized in the region overlapping the pixel electrode 13B. In addition, the partial external natural light beam L241 is transmitted through the display panel PNL, and therefore the user can also visually recognize the background on the upper surface 20T side through the display panel PNL. Note that in the region overlapping the pixel electrode 13A, the liquid crystal layer 30 is in the transparent state, and therefore the color of the light beam L21 cannot be substantially visually recognized, and whereas the background can be visually recognized by the user through the display panel PNL.

<Liquid Crystal Material Composition>

The liquid crystal layer 30 is formed of a liquid crystal material composition. The liquid crystal material composition contains a liquid crystal mixture containing at least one kind of a first liquid crystalline compound, at least one kind of a second liquid crystalline compound and at least one kind of a third liquid crystalline compound, a polymerization initiator, and a monomer compound including acryloyl groups at respective terminals.

[First Liquid Crystalline Compound]

The first liquid crystalline compound contains a first aromatic ring containing a halogen group, a second aromatic ring including a halogens group and bonded to the first aromatic ring through a first bond and a third aromatic ring including an aliphatic group and bonded to the second aromatic ring through a second bond. The first liquid crystalline compound can be represented in following formula (1).

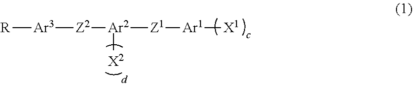

In the in chemical formula (1), X and X independently represent fluorine atoms, chlorine atoms, bromine atoms or iodine atoms respectively, Ar¹, Ar² and Ar³ independently represent benzene rings or naphthalene rings, respectively, R represents an aliphatic group having one to ten carbon atoms, Z¹ and Z² independently represent a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH═CH—, —C═C—, —CF₂O—, —OCF₂—, —COO— or —OCO—, and c and d independently represent 1, 2 or 3, respectively.

In the formula (1), X¹ and X² are each equivalent to a halogen group. It is preferable that the halogen group be, for example, a fluorine atom or chlorine atom.

R is equivalent to an aliphatic group. The aliphatic group is, for example, an alkyl group having one to ten carbon atoms, an alkenyl group having two to ten carbon atoms or an alkynyl groups having two to ten carbon atoms.

Ar¹ is equivalent to the first aromatic ring. To the first aromatic ring, one to three X¹ corresponding to the halogen group are bonded. When two or more halogen groups are bonded the first aromatic ring, the halogen groups may be the same as or different from each other.

Ar² is equivalent to the second aromatic ring. To the second aromatic ring, one to three X² corresponding to the halogen group are bonded. When two or more halogen groups are bonded to the second aromatic ring, the halogen groups may be the same as or different from each other.

Ar³ is equivalent to the third aromatic ring. To the third aromatic ring, one R corresponding to the aliphatic group is bonded. To the third aromatic ring, two or more Rs may be bonded or some other organic group than the aliphatic group may be bonded.

Z¹ corresponds to the first bond, and Z² corresponds to the second bond.

In a structure of the first liquid crystalline compound as above, the first aromatic ring including a halogen group can be represented by one of the following formulas (2-1) to (2-8).

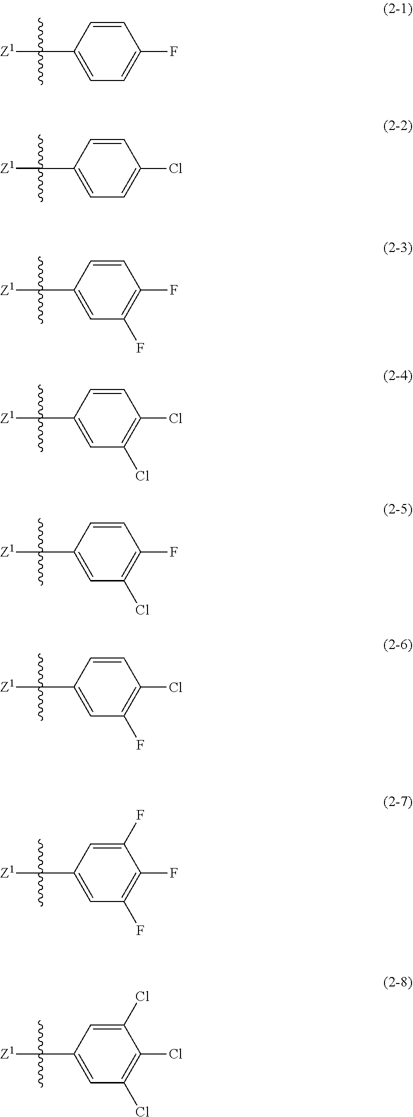

Further, in a structure of the first liquid crystalline compound, the second aromatic ring including a halogen group can be represented by one of the following formulas (3-1) to (3-11).

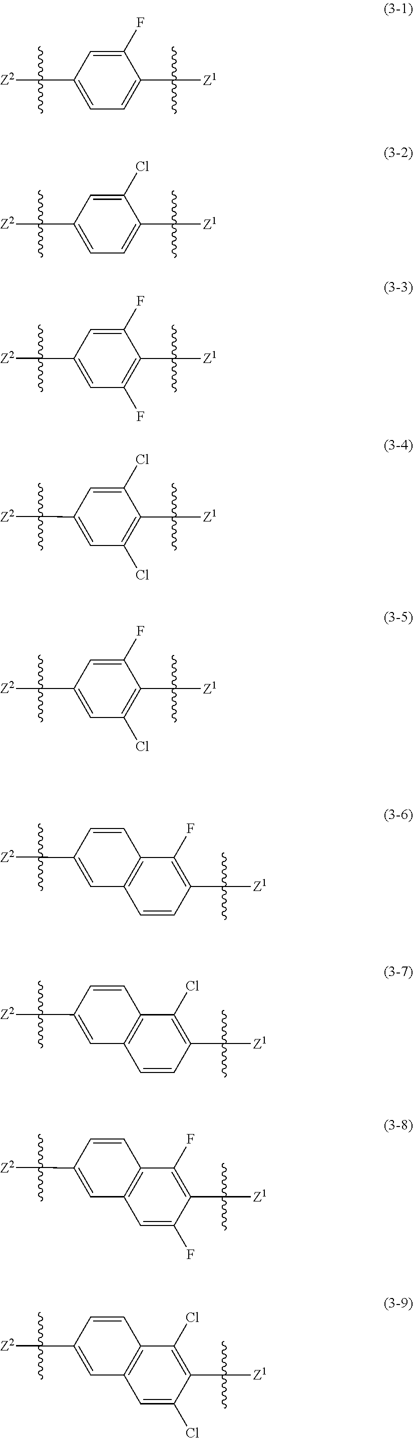

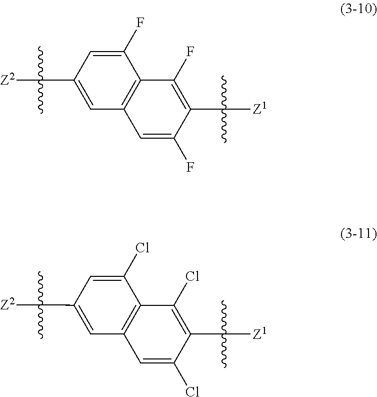

Further, in a structure of the first liquid crystalline compound, the third aromatic ring including an aliphatic group can be represented in the following formula (4-1) or (4-2).

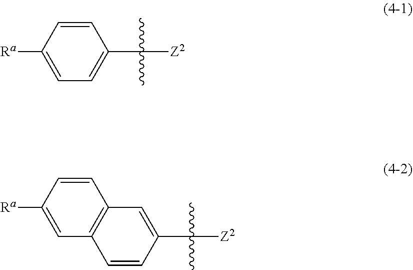

In the above-provided formulas (4-1) and (4-2), R^{a} is an alkyl group having one to ten carbon atoms.

[Second Liquid Crystalline Compound]

The second liquid crystalline compound contains a first aromatic ring including a halogen group, a second aromatic ring including a halogens group and bonded to the first aromatic ring through the first bond, and a first alicyclic group including an aliphatic group and bonded to the second aromatic ring through the third bond. The second liquid crystalline compound having such a structure as above can be represented by the following formula (5).

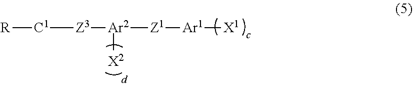

In the formula (5), X¹ and X² are each as defined in the above-provided formula (1), Ar¹ and Ar² are each as defined in the above-provided formula (1), C¹ is 1,4-cyclohexyl group, Z¹ is as defined in the above-provided formula (1), Z³ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH═CH—, —C═C—, —CF₂O—, —OCF₂—, —COO—, —OCO— or 1,4-cyclohexyl group, and c and d are each as defined in the above-provided formula (1), and R is as defined in the above-provided formula (1).

In the above formula (5), C¹ corresponds to the first alicyclic group and Z³ corresponds to the third bond.

In a structure of the second liquid crystalline compound as above, the first aromatic ring including a halogen group can be represented by one of the above formulas (2-1) to (2-8).

Further, in a structure of the second liquid crystalline compound, the second aromatic ring including a halogen group can be represented by one of the above formulas (3-1) to (3-11). Note that, in a structure of the second liquid crystalline compound as above, Z³ corresponding to the third bond is bonded to the second aromatic ring including a halogen group in place of Z² corresponding to the second bond.

Further, in a structure of the second liquid crystalline compound, the first alicyclic group having an aliphatic group can be represented in following formula (6).

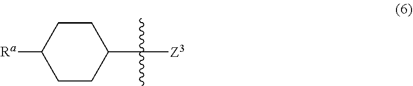

In the above formula (6), R^{a} is as defined by the above formulas (4-1) and (4-2).

[Third Liquid Crystalline Compound]

The third liquid crystalline compound contains a fourth aromatic ring, a fifth aromatic ring bonded to the fourth aromatic ring through the fourth bond, a second alicyclic group including an aliphatic group and bonded to the fourth aromatic ring through the fifth bond and a third alicyclic group including an aliphatic group and bonded to the fifth aromatic ring through the sixth bond. The third liquid crystalline compound having such a structure can be represented by the following formula (7).

R—C²—Z⁵—Ar⁴—Z⁴—Ar⁵—Z⁶—C³—R (7)

In the formula (7), Ar⁴ and Ar⁵ independently represent benzene rings or naphthalene rings, respectively, R is as defined in the formula (1), Z⁴, Z⁵ and Z⁶ independently represent a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH═CH—, —C═C—, —CF₂O—, —OCF₂—, —COO— or —OCO—, and C² and C³ are each independently a 1,4-cyclohexyl group.

In the above formula (7), Ar⁴ is equivalent to the fourth aromatic ring, and Ar⁵ is equivalent to the fifth aromatic ring. To each of the fourth aromatic ring and the fifth aromatic ring, a halogen atom may be independently bonded.

Z⁴ is equivalent to the fourth bond, Z⁵ is equivalent to the fifth bond, and Z⁶ is equivalent to the sixth bond.

C² is equivalent to the second alicyclic group, and C³ is equivalent to the third alicyclic group.

In the structure of the third liquid crystalline compound as above, the fourth aromatic ring can be represented by the following formula (8-1) or (8-2).

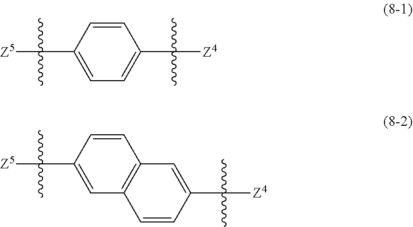

Further, in the structure of the third liquid crystalline compound, the fifth aromatic ring can be represented by one of the following formulas (9-1) to (9-6).

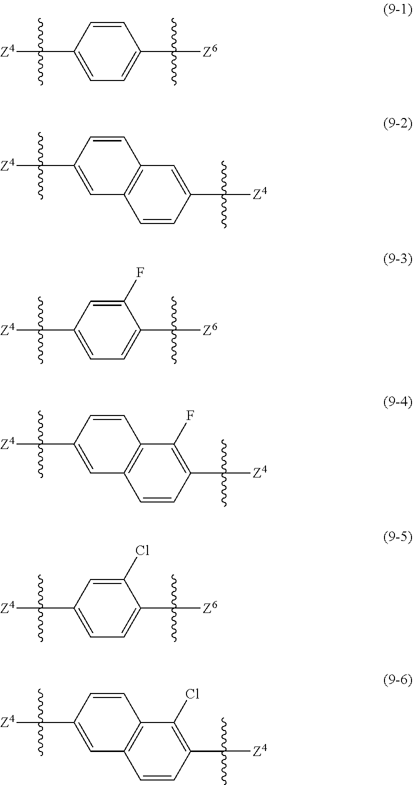

Further, in the structure of the third liquid crystalline compound, the second alicyclic group including an aliphatic group can be represented by the following formulas (10).

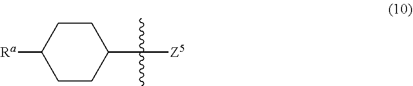

In the above formula (10), R^{a} is as defined by the above formulas (4-1) and (4-2).

Further, in the structure of the third liquid crystalline compound, the third alicyclic group including an aliphatic group can be represented by the following formula (11).

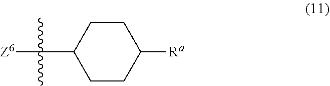

In the above formula (11), R^{a} is as defined by the above formulas (4-1) and (4-2).

The liquid crystal mixture contains at least one kind of each of the first liquid crystalline compound, the second liquid crystalline compound and the third liquid crystalline compound can contain, for example, within a range of 5 to 50 parts by weight when a total weight of the first liquid crystal compound, the second liquid crystalline compound and the third liquid crystalline compound is set to 100 parts by weight. The liquid crystal mixture contains, for example, one to ten kinds of the first liquid crystalline compounds, one to five kinds of the second liquid crystalline compounds, and one to five kinds of the third liquid crystalline compounds.

[Monomer Compound]

The liquid crystal material composition contains a monomer compound including acryloyl groups at respective terminals. Such a monomer compound can be represented in the following formula (12).

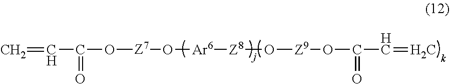

In the formula (12), Z⁷ and Z⁹ independently represent alkylene groups having one to ten carbon atoms, respectively, and Z⁸ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOH₂CH₂—, —CH═CH—, —C═C—, —CF₂O—, —OCF₂—, —COO— or —OCO—, Ar⁶ represents a benzene ring, j is 1, 2 or 3, and k is 1 or 2.

In the above formulas (12), Ar⁶ may be substituted by a phenyl group an alkoxy group, or an alkyl group having one to five carbon atoms.

In the above formula (12), when j is 2 or 3, plurality of Ar⁶ and Z⁸ may be the same as or different from each other. Further, when k is 2, a plurality of Z⁹ may be the same as or different from each other.

Such a monomer compound can be represented specifically by the following formulas (13-1) to (13-14).

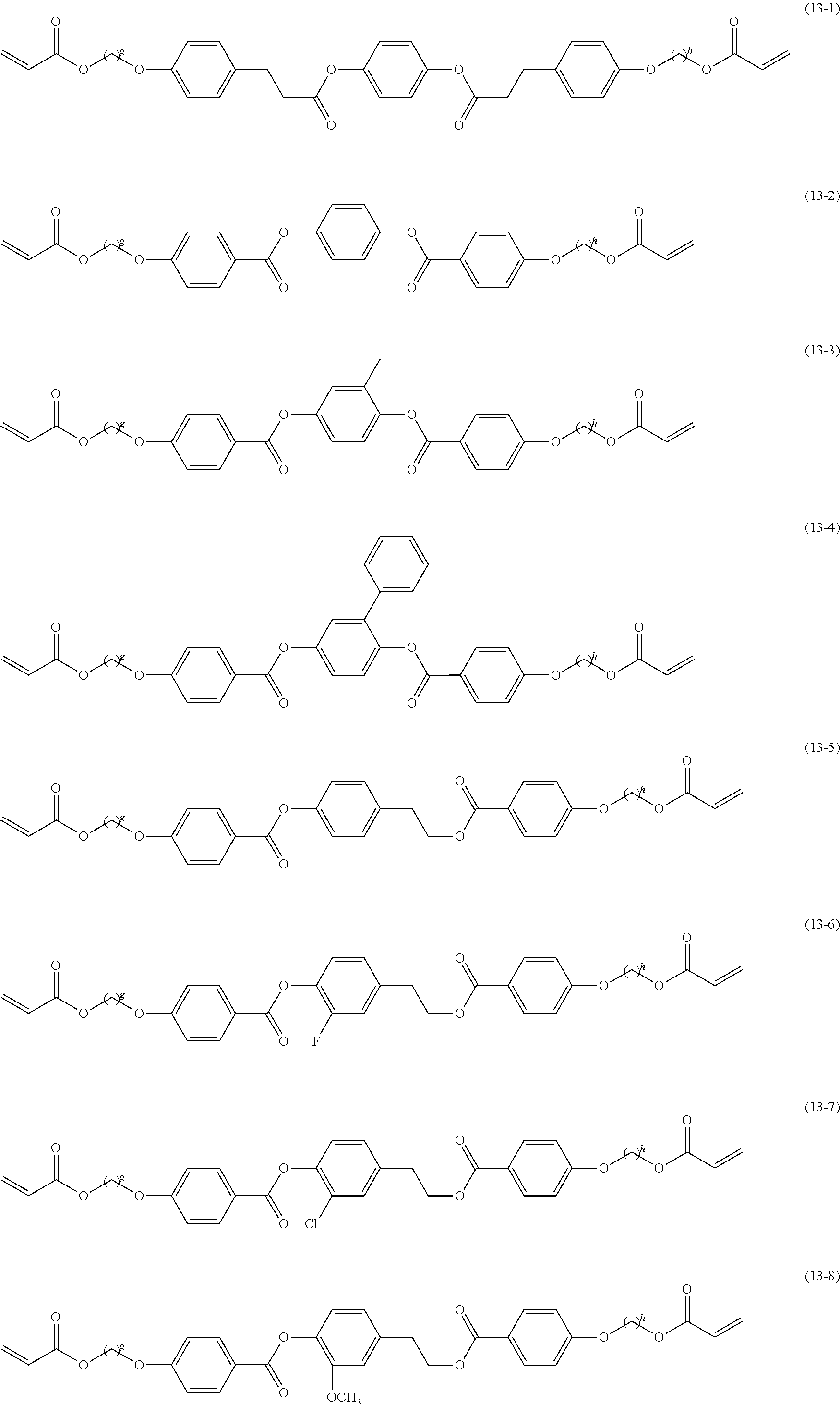

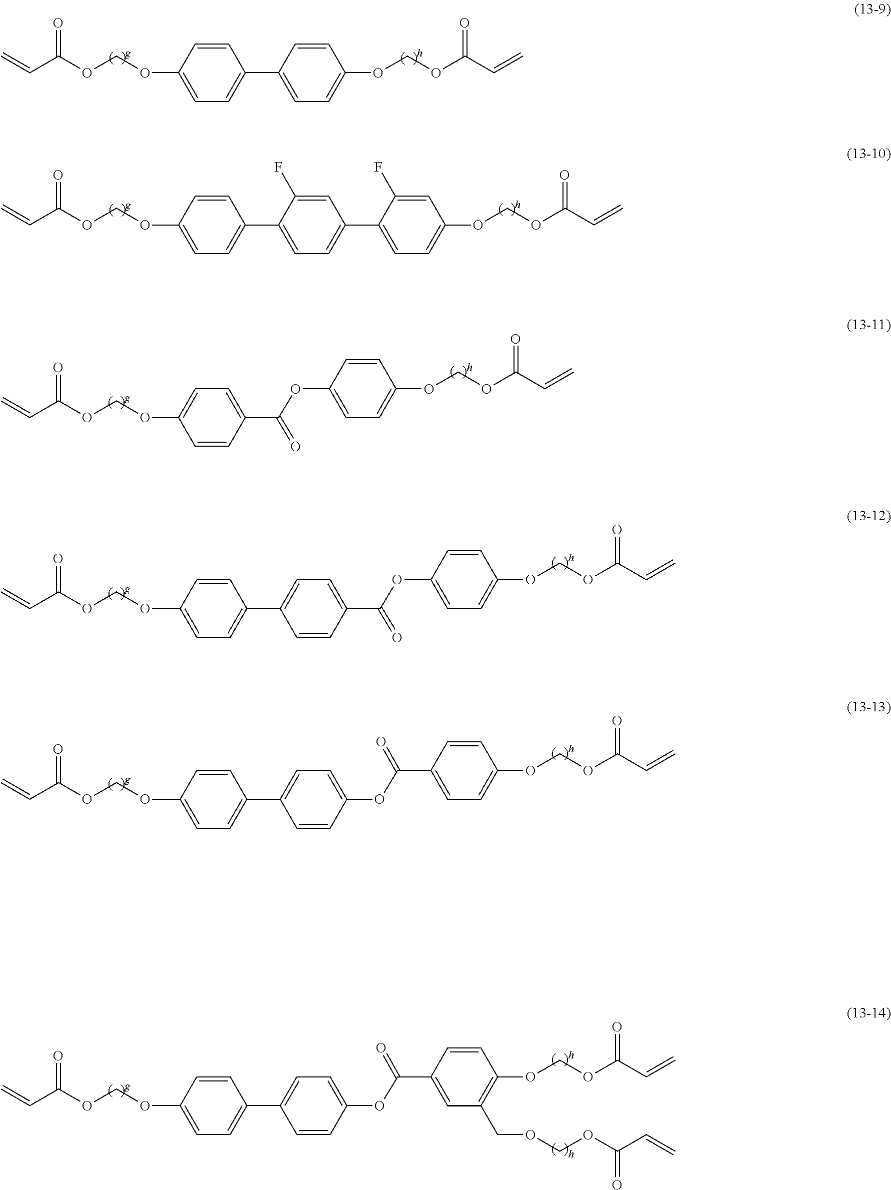

In the above formulas (13-1) to (13-14), g and h independently represent integers of 1 to 10, respectively.

The polymer originated from the monomer compound including acryloyl groups at respective terminals has, for example, a repetitious structural unit represented by the following formula (14).

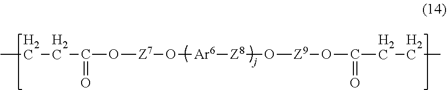

In the formula (14), Z⁷, Z⁸, Z⁹, Ar⁶ and j are each as defined by the above formula (12).

[Polymerization Initiator]

The polymerization initiator is a compound which produces active species such as radicals, cations or anions in a chain polymerization such as radical polymerization, cationic polymerization or anionic polymerization, and initiates the chain polymerization of monomer compounds. The polymerization initiator polymerizes, for example, the monomer compounds in chain polymerization and forms the polymers 31 originated from the monomer compounds.

The polymerization initiator is, for example, a heat polymerization initiator, which produces active species by heating. The heat polymerization initiator is, for example, a heat radical polymerization initiator or a heat cation polymerization initiator.

The heat radical polymerization initiator contains, for example, an azo-based compound or a peroxide-based compound.

The azo-based compound is, for example, 2,2′-azobis(isobutyronitrile), 2,2′-azobis(2-methylbutyronitrile), 2,2′-azobis(2,4-dimethylvaleronitrile), 4,4′-azobis (4-cyanovaleric acid), 2,2′-azobis(2-methylpropionate)dimethyl, 2,2′-azobis(2-methylpropionamidine)dihydrochloride or 2,2′-azobis[2-(2-imidazoline-2-yl)propane]dihydrochloride.

The peroxide-based compound is, for example, tert-butyl hydroperoxide, cumene hydroperoxide, di-tert-butylperoxide, dicumyl peroxide or benzoyl peroxide.

The heat-cationic polymerization initiator is, for example, dicyandiamide, cyclohexyl p-toluenesulfonate, diphenyl(methyl)sulfonium tetrafluoroborate, benzyl(4-hydroxyphenyl) methylsulfonium hexafluoroantimonate, or (4-hydroxyphenyl)methyl(2-methyl benzyl) sulfonium hexafluoroantimonate.

Such a heat polymerization initiator produces active species, for example, when heated to 80° C. or higher, and then polymerizes the monomer compounds contained in the liquid crystal material composition to form the polymers 31. Note that in some embodiments, it is preferable to heat the heat polymerization initiator to 90° C. or higher, or more preferably 100° C. or higher.

Further, the polymerization initiator may be, for example, a photopolymerization initiator, which produces active species by irradiation of ultraviolet radiation, electron beam or the like. The photopolymerization initiator is, for example, a photo-radical polymerization initiator, a photo-cation polymerization initiator or a photo-anion polymerization initiator.

The photo-radical polymerization initiator contains, for example, a benzophenone-based compound, an acetophenone-based compound, a benzoin-based compound, a thioxanthone-based compound or a phosphine oxide-based compound.

The benzophenone-based compound is, for example, benzophenone, 4-benzoylbenzoic acid, 2-benzoylbenzoic acid, methyl 2-benzoylbenzoate, 4,4′-bis (dimethylamino)benzophenone, 4,4′-bis (diethylamino)benzophenone, 4,4′-dichlorobenzophenone, 1,4′-dibenzoyl benzene, 4-methyl benzophenone, hydroxy benzophenone, 2,4,6-trimethyl benzophenone, 4-phenyl benzophenone, 4-methoxy-3,3′-dimethyl benzophenone, 4-benzoyl 4′-methyl diphenyl sulfide or 4,4′-carbonylbis(diperoxyphthalic acid di-tert-butyl).

The acetophenone-based compound is, for example, acetophenone, 2-hydroxy-2-methyl propiophenone, 2-hydroxy-4′-(2-hydroxyethoxy)-2-methyl propiophenone, 1-hydroxycyclohexyl phenyl ketone, 2-methyl-4′-(methylthio)-2-morpholino propiophenone, 2-benzyl-2-dimethylamino)-4′-morpholino butyrophenone, 2-isonitroso propiophenone, or 1-(4-isopropylphenyl)-2-hydroxy-2-methylpropane-1-one.

The benzoin-based compound is, for example, benzoin, benzoin methyl ether, benzoin ethyl ether, benzoin isopropyl ether, benzoin isobutyl ether, 2-phenyl-2-(p-toluene sulfonyloxy)acetophenone, 2,2-diethoxy acetophenone or 2,2-dimethoxy-2-phenyl acetophenone.

The thioxanthone-based compound is, for example, 2-chlorothioxanthone, 2,4-dichlorothioxanthone, 2-isopropyl thioxanthone or 2,4-diethyl thioxanthene-9-one.

The phosphine oxide-based compound is, for example, diphenyl(2,4,6-trimethyl benzoyl)phosphine oxide, phenyl bis(2,4,6-trimethyl benzoyl)phosphine oxide, or lithium phenyl(2,4,6-trimethyl benzoyl)phosphinate.

The photo-radical polymerization initiator may be, besides the compounds listed above, (±)-camphorquinone, benzil, benzoyl methyl formate, p-anisil, 2-ethyl anthraquinone, 2,2′-bis(2-chlorophenyl)-4,4′,5,5′-tetraphenyl-1,2′-biimidazole, or 1-(9-ethyl-9H-carbazol-3-yl)ethanone O-acetyl oxime.

The photo-cation polymerization initiator contains, for example, an iodonium salt-based compound, a sulfonium salt-based compound, or an triazine-based compound.

The iodonium salt-based compound is, for example, diphenyliodonium trifluoromethanesulfonate, diphenyliodonium hexafluorophosphate, diphenyliodonium hexafluoroarsenate, bis (4-tert-butylphenyl)iodonium triflate, bis(4-tert-butylphenyl)iodonium hexafluorophosphate or 4-isopropyl-4′-methyldiphenyliodonium tetrakis (pentafluorophenyl)borate.

The sulfonium salt-based compound is, for example, cyclopropyldiphenylsulfonium tetrafluoroborate, triphenyl sulfonium bromide, triphenyl sulfonium tetrafluoroborate, tri-p-tolyl sulfonium trifluoromethanesulfonate, or tri-p-tolyl sulfonium hexafluorophosphate.

The triazine-based compound is, for example, 2-(4-methoxyphenyl)-4,6-bis(trichloromethyl)-1,3,5-triazine, 2-(1,3-benzodioxole-5-yl)-4,6-bis(trichloromethyl)-1,3,5-triazine, 2-(4-methoxystyryl)-4,6-bis(trichloromethyl)-1,3,5-triazine, 2-(3,4-dimethoxy styryl)-4,6-bis(trichloromethyl)-1,3,5-triazine, 2-[2-(furan-2-yl)vinyl]-4,6-bis(trichloromethyl)-1,3,5-triazine or 2-[2-(5-methylfuran-2-yl)vinyl]-4,6-bis(trichloromethyl)-1,3,5-triazine.

The photo-cation polymerization initiator may be 4-nitrobenzenediazonium tetrafluoroborate in addition to the compounds provided above.

The photo-anion polymerization initiator is, for example, 2-(9-oxoxanthene-2-yl)propionate 1,5,7-triazabicyclo[4.4.0]dec-5-ene, 2-(9-oxoxanthene-2-yl)propionate 1,5-diazabicyclo[4.3.0]non-5-ene, 2-(9-oxoxanthene-2-yl)propionate 1,8-diazabicyclo[5.4.0]undec-7-ene, acetophenone O-benzoyl oxime, cyclohexylcarbamate 2-nitrobenzyl, cyclohexylcarbamate 1, 2-bis(4-methoxyphenyl)-2-oxoethyl, or nifedipine.

Such a photo-polymerization initiator produces active species, for example, by irradiation of ultraviolet rays, and thus polymerizes the monomer compounds contained in the liquid crystal material composition. The photo-polymerization initiator has a sensitivity wavelength region to the ultraviolet radiation in a range of approximately, for example, 350 to 380 nm.

Usable examples of the light source which generates ultraviolet rays for irradiation are a metal halide lamp, a high-pressure mercury lamp and a super-high-pressure mercury lamp.

It is preferable that the wavelength of ultraviolet radiation may be in an absorption wavelength range of the photo-polymerization initiators listed above, and the ultraviolet rays of an absorption wavelength range which is not the absorption wavelength range of the liquid crystal mixture contained in the liquid crystal material composition. More specifically, it is preferable to use a metal halide lamp, a high-pressure mercury lamp or a super-high-pressure mercury lamp, by cutting ultraviolet rays of 330 nm or less, or more preferably, 350 nm or less. It is also preferable to use a UV-LED lamp which can irradiate a single wavelength.

The exposure amount of the ultraviolet radiation should preferably be 10 to 10000 mJ/cm², and more preferably, 50 to 5000 mJ/cm².

The illuminance of the ultraviolet radiation should preferably be 1 to 200 mW/cm², and more preferably 2 to 100 mW/cm².

The time period for irradiating the ultraviolet rays should be selected appropriately according to the intensity of the ultraviolet radiation, but it should preferably be 10 to 600 seconds. More preferably, the UV-exposure should be carried out to achieve 1200 mJ/cm² to 2400 mJ/cm².

Further, the amount of the polymerization initiators is, for example, 0.1 to 30% by weight to the monomer compound, should preferably be 1 to 20% by weight, and more preferably 5 to 15% by weight.

According to the present embodiment, with use of such a liquid crystal material composition, a display device with an improved display quality can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal material composition comprising a liquid crystal mixture containing at least one kind of a first liquid crystalline compound, at least one kind of a second liquid crystalline compound and at least one kind of a third liquid crystalline compound, a polymerization initiator and a monomer compound including acryloyl groups at respective terminals,
the at least one kind of the first liquid crystalline compound containing a first aromatic ring including a halogens group, a second aromatic ring including a halogens group and bonded to the first aromatic ring through a first bond, and a third aromatic ring including an aliphatic group and bonded to the second aromatic ring through a second bond,
the at least one kind of the second liquid crystalline compound containing a first aromatic ring including a halogens group, a second aromatic ring including a halogens group and bonded to the first aromatic ring through the first bond and a first alicyclic group including an aliphatic group and bonded to the second aromatic ring through a third bond, and
the at least one kind of the third liquid crystalline compound containing a fourth aromatic ring, a fifth aromatic ring bonded to the fourth aromatic ring through a fourth bond, a second alicyclic group including an aliphatic group and bonded to the fourth aromatic ring through a fifth bond, and a third alicyclic group including an aliphatic group and bonded to the fifth aromatic ring through a sixth bond.

2. The composition of claim 1, wherein
the first and second bonds are each accomplished by a single bond or an aliphatic group.

3. The composition of claim 1, wherein
the third bond is accomplished by a single bond, an aliphatic group or an alicyclic group.

4. The composition of claim 1, wherein
the fourth, fifth and sixth bonds are each accomplished by a single bond or an aliphatic group.

5. The composition of claim 1, wherein
the first, second and third aromatic rings each are a benzene ring or a naphthalene ring.

6. The composition of claim 1, wherein
the fourth and fifth aromatic rings each are a benzene ring or a naphthalene ring.

7. The composition of claim 1, wherein
the first alicyclic group is a cyclohexyl group.

8. The composition of claim 1, wherein
the polymerization initiator is a photopolymerization initiator.

9. A display device comprising:
a first substrate;
a second substrate opposing the first substrate;
a liquid crystal layer located between the first substrate and the second substrate and containing a liquid crystal mixture containing at least one kind of a first liquid crystalline compound, at least one kind of a second liquid crystalline compound and at least one kind of a third liquid crystalline compound, and a polymer originated from a monomer compound including acryloyl groups at respective terminals; and
an alignment film located on the first substrate and in contact with the liquid crystal layer,
the at least one kind of the first liquid crystalline compound containing a first aromatic ring including a halogens group, a second aromatic ring including a halogens group and bonded to the first aromatic ring through a first bond, and a third aromatic ring including an aliphatic group and bonded to the second aromatic ring through a second bond,
the at least one kind of the second liquid crystalline compound containing a first aromatic ring including a halogens group, a second aromatic ring including a halogens group and bonded to the first aromatic ring through the first bond and a first alicyclic group including an aliphatic group and bonded to the second aromatic ring through a third bond, and
the at least one kind of the third liquid crystalline compound containing a fourth aromatic ring, a fifth aromatic ring bonded to the fourth aromatic ring through a fourth bond, a second alicyclic group including an aliphatic group and bonded to the fourth aromatic ring through a fifth bond, and a third alicyclic group including an aliphatic group and bonded to the fifth aromatic ring through a sixth bond.

10. The device of claim 9, wherein
the first and second bonds are each accomplished by a single bond or an aliphatic group.

11. The device of claim 9, wherein
the third bond is accomplished by a single bond, an aliphatic group or an alicyclic group.

12. The device of claim 9, wherein
the fourth, fifth and sixth bonds are each accomplished by a single bond or an aliphatic group.

13. The device of claim 9, wherein
the first, second and third aromatic rings each are a benzene ring or a naphthalene ring.

14. The device of claim 9, wherein
the fourth and fifth aromatic rings each are a benzene ring or a naphthalene ring.

15. The device of claim 9, wherein
the first alicyclic group is a cyclohexyl group.
